(19) United States
(12) Patent Application Publication
(10) Pub. No.: US 2024/0070671 A1
(43) Pub. Date: Feb. 29, 2024

(54) SYSTEMS AND METHODS FOR DETECTING FRAUDULENT ACTIVITY

(71) Applicant: Capital One Services, LLC, McLean, VA (US)

(72) Inventors: Allison Fenichel, Brooklyn, NY (US); Marianne Huang, Palo Alto, CA (US); Salina Kroker, Riverview, FL (US)

(21) Appl. No.: 17/893,283

(22) Filed: Aug. 23, 2022

(51) Int. Cl. G06Q 20/40; H04L 9/40

(52) U.S. Cl. CPC G06Q 20/4016; H04L 63/1483

(57) ABSTRACT

Disclosed embodiments may include a system for detecting fraudulent activity. The system may determine that a user has navigated to a website associated with an entity, and may receive click data associated with the website. The system may receive a request to complete a transaction, and may retrieve transaction data associated with the transaction. The system may determine a probability of fraud associated with the entity, and may determine whether the probability exceeds a predetermined threshold. Responsive to determining the probability exceeds the predetermined threshold, the system may transmit a notification comprising selectable user input object(s) to the user device, and may cause the user device to display the notification via a GUI. Responsive to receiving a first selection of a first user input object of the selectable user input object(s), the system may decline the transaction and update the GUI to indicate the transaction is declined.

The disclosed technology relates to systems and methods for detecting fraudulent activity. Specifically, this disclosed technology relates to verifying a website is not associated with malicious activity.

### BACKGROUND

With the increasing prevalence of online transactions, customers are at an increased risk of conducting transactions with fraudulent merchants and entities, such as through fraudulent websites. Identifying fraudulent merchants, entities, and/or websites can become a challenge to customers as fraudulent parties and platforms may appear, at least at initial glance, to provide data and transaction capabilities comparable to a legitimate party or platform.

Accordingly, there is a need for improved systems and methods for detecting fraudulent activity. Embodiments of the present disclosure may be directed to this and other considerations.

### SUMMARY

Disclosed embodiments may include a system for verifying a website is not associated with malicious activity. The system may include one or more processors, and memory in communication with the one or more processors and storing instructions that, when executed by the one or more processors, are configured to cause the system to detect fraudulent activity. The system may determine that a user has navigated to a website associated with an entity. The system may receive, via a web browser plugin on a user device, first click data associated with the website. The system may receive a request to complete a transaction via the website. The system may retrieve transaction data associated with the transaction. The system may determine, via a machine learning model (MLM), a probability of fraud associated with the entity based on the first click data and the transaction data. The system may determine, via the MLM, whether the probability of fraud exceeds a first predetermined threshold. Responsive to determining the probability of fraud exceeds the first predetermined threshold, the system may transmit a notification to the user device, the notification comprising one or more selectable user input objects; and cause the user device to display the notification via a graphical user interface (GUI). Responsive to receiving, via the GUI of the user device, a first selection of a first user input object of the one or more selectable user input objects, the system may decline the transaction and update the GUI to indicate the transaction is declined.

Disclosed embodiments may include a system for verifying a website is not associated with malicious activity. The system may include one or more processors, and memory in communication with the one or more processors and storing instructions that, when executed by the one or more processors, are configured to cause the system to detect fraudulent activity. The system may determine that a user has navigated to a website associated with an entity. The system may receive, via a web browser plugin on a user device, first click data associated with the website. The system may receive a request to complete a transaction. The system may receive transaction data associated with the transaction. The system may determine, via an MLM, a probability of fraud associated with the entity based on the first click data and the transaction data. The system may determine, via the MLM, whether the probability of fraud exceeds a first predetermined threshold. Responsive to determining the probability of fraud exceeds the first predetermined threshold, the system may transmit a notification to the user device, the notification comprising one or more selectable user input objects, and cause the user device to display the notification via a GUI. The system may receive, via the GUI of the user device, a first selection of a first user input object of the one or more selectable user input objects. Responsive to receiving the first selection, the system may authorize the transaction.

Disclosed embodiments may include a system for verifying a website is not associated with malicious activity. The system may include one or more processors, and memory in communication with the one or more processors and storing instructions that, when executed by the one or more processors, are configured to cause the system to detect fraudulent activity. The system may determine that a user has navigated to a website associated with an entity. The system may receive, via a web browser plugin on a user device, first click data associated with the website. The system may determine, via an MLM, a probability of fraud associated with the entity based on the first click data. The system may determine, via the MLM, whether the probability of fraud exceeds a first predetermined threshold. Responsive to determining the probability of fraud exceeds the first predetermined threshold, the system may transmit a notification to the user device, and cause the user device to display the notification via a GUI.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for detecting fraudulent activity in accordance with certain embodiments of the disclosed technology.

FIG. 2 is block diagram of an example fraud detection system used to detect fraudulent activity, according to an example implementation of the disclosed technology.

FIG. 3 is block diagram of an example system that may be used to detect fraudulent activity, according to an example implementation of the disclosed technology.

### DETAILED DESCRIPTION

Traditional systems and methods for detecting fraudulent activity may require users or customers to conduct their own review of certain entities, such as by reading online reviews by other customers, prior to conducting transactions. In addition to conducting upfront research, customers may also need to track their conducted transactions and payments through their bank to ensure payments are properly and accurately processed, and do not require dispute. These systems and methods may be burdensome on customers and prone to errors.

Accordingly, examples of the present disclosure may provide for the use of a web browser plugin that may recognize potential malicious activity by a merchant and/or on a merchant-affiliated website. The systems and methods disclosed herein may provide for receiving data corresponding to a website and/or a customer's initiated or pending transaction via a website, and using the data to determine a probability that the applicable merchant or entity is associated with fraudulent or malicious activity. Based on determining this probability, the systems and methods disclosed herein may provide for the transmitting of notifications to customers, and the authorizing or declining of transactions based on customers' selections of certain prompts contained within the notifications.

The systems and methods described herein may utilize, in some instances, machine learning models (MLMs) and graphical user interfaces (GUIs), which are necessarily rooted in computers and technology. Machine learning models are a unique computer technology that involves training models to complete tasks and make decisions. Graphical user interfaces are a computer technology that allows for user interaction with computers through touch, pointing devices, or other means. The present disclosure details determining a user has navigated to a website associated with an entity, and determining a probability of fraud associated with the entity based on user data, such as click data and/or transaction data. This, in some examples, may involve using user-specific input data and an MLM, applied to determine a probability of fraud associated with the entity and whether that probability exceeds a predetermined threshold, and to output a result of modifying a GUI in such a way as to notify a customer of a potential fraudulent transaction. Using an MLM and GUI in this way may allow the system to autonomously verify potential security risks associated with entities and/or websites, and provide a modified GUI for display to a user to indicate such security risks. This is a clear advantage and improvement over prior technologies that do not provide for automatic monitoring and determining of potentially fraudulent websites as these technologies may be burdensome to customers and prone to errors. The present disclosure solves this problem by automatically recognizing a user has navigated to a website associated with an entity, and using historical and user-specific data to determine whether the entity may be a security risk to the customer. Furthermore, examples of the present disclosure may also improve the speed with which computers can determine potentially fraudulent activity. Overall, the systems and methods disclosed have significant practical applications in the online security field because of the noteworthy improvements of the ability to recognize potential fraud and notify customers prior to and/or following the completion of transactions, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

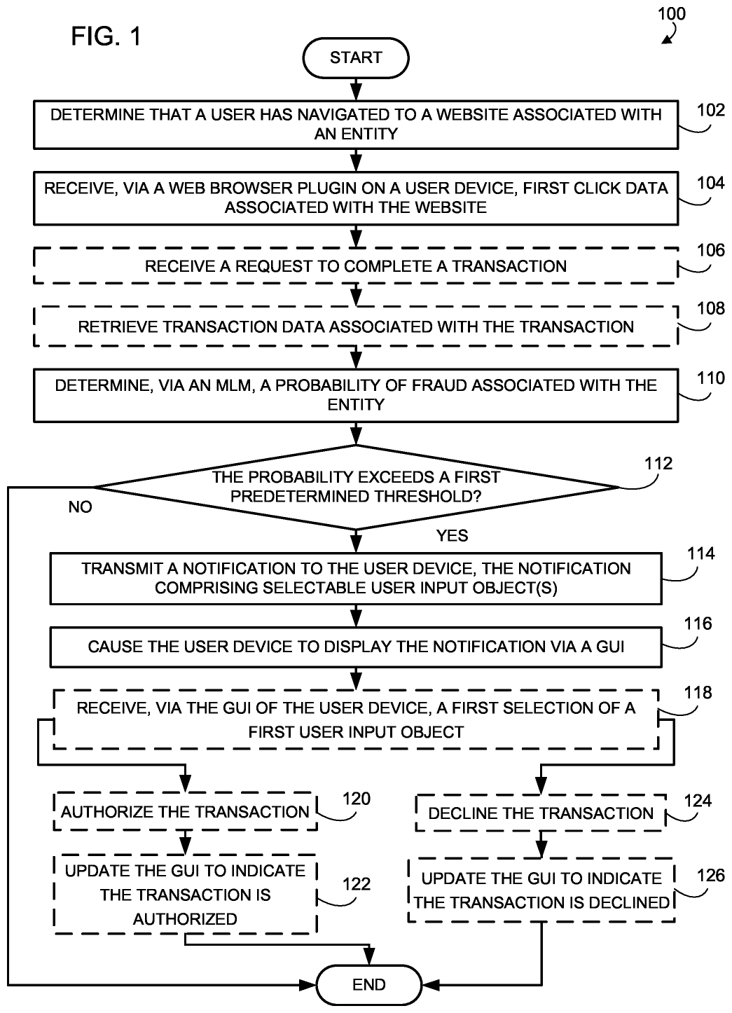

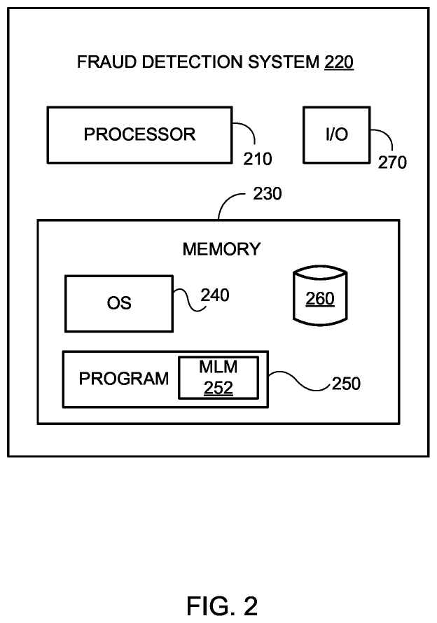

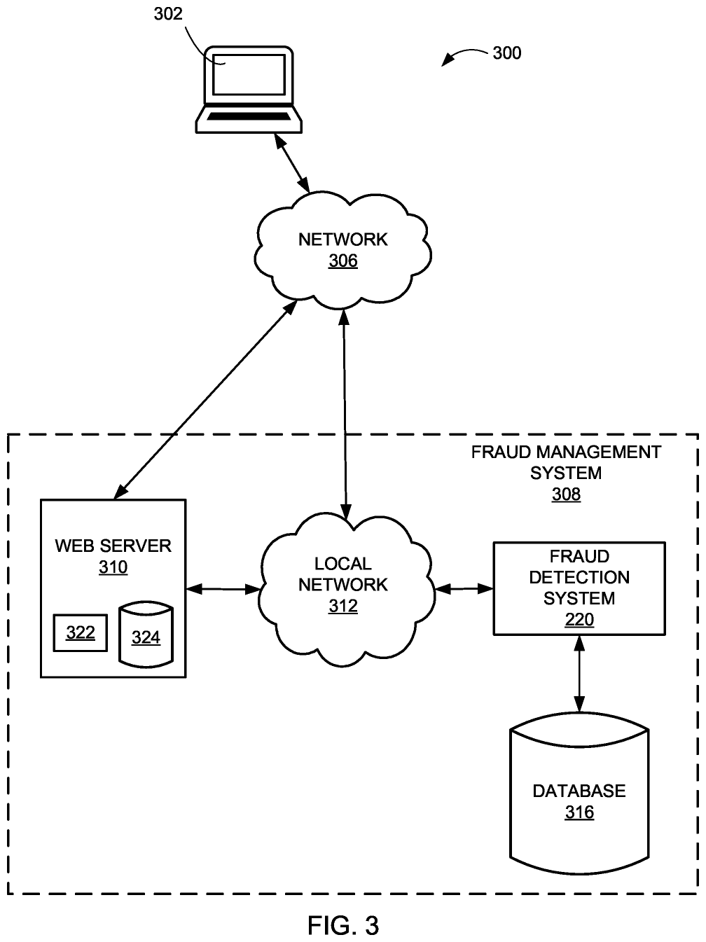

FIG. 1 is a flow diagram illustrating an exemplary method 100 for detecting fraudulent activity, in accordance with certain embodiments of the disclosed technology. The steps of method 100 may be performed by one or more components of the system 300 (e.g., fraud detection system 220 or web server 310 of fraud management system 308 or user device 302), as described in more detail with respect to FIGS. 2 and 3.

In block 102, the fraud detection system 220 may determine that a user has navigated to a website associated with an entity. In some embodiments, the system may be configured to make such determination via a web browser plugin running on a user device associated with the user. For example, the web browser plugin may be owned and/or operated by the same organization that may own and/or operate the fraud detection system 220. The browser plugin may be configured such that when running on a user device, the plugin may recognize when a user has navigated to an entity website, such as by recognizing an entity name, a uniform resource locator (URL), or any other entity information contained within the webpage.

In block 104, the fraud detection system 220 may receive, via a web browser plugin on the user device, first click data associated with the website. In some embodiments, first click data may include data associated with portions of a GUI and/or webpage to which a user navigates (e.g., via a mouse and/or cursor) and/or selects (e.g., via a click or selection of a touchscreen component). In some embodiments, first click data may include data corresponding to information relevant to a user's webpage and/or web browsing activity. For example, the first click data may include, for example, a referring URL, a current URL, a date, a time, account identification data, user identification data, and the like. The account identification data may include information associated with the user's account corresponding to the entity itself, the website, and/or the organization that may own and/or operate the browser plugin and/or the fraud detection system 220. The user identification data may include personal information the user enters into the website and/or the browser plugin. The first click data may provide the system with information associated with the entity and/or website that may enable the system to more easily predict whether the entity or website is potentially fraudulent, as further discussed below.

In optional block 106, the fraud detection system 220 may receive a request to complete a transaction via the website. For example, the system may be configured to recognize that the user has initiated a transaction by entering payment information into the GUI, clicked on a selectable object within the GUI (e.g., a “pay” or “submit” button), and the like. In some embodiments, an organization that owns and/or operates fraud detection system 220 may be one in which the user has user accounts, such as financial accounts, such that the system may be configured to receive a notification and/or transaction information when the user initiates a transaction with the entity via the website.

In optional block 108, the fraud detection system 220 may retrieve transaction data associated with the transaction. In some embodiments, as discussed above, the system may be configured to retrieve transaction data from within received notifications and/or transaction information associated with the user in such cases where the user may be a customer of an organization that owns and/or operates the system. In some embodiments, the system may be configured to retrieve transaction data via, for example, a transaction data aggregator that may connect to a user's one or more accounts via an Application Programming Interface (API).

In block 110, the fraud detection system 220 may determine, via an MLM, a probability of fraud associated with the entity. In some embodiments, the MLM may be trained on a set of training data including information associated with various entities, such as websites, URLs, historical transaction data, and/or customer dispute data, such that the MLM may either recognize the current entity as one the model has seen before, or predict whether a new entity may be indicative of a fraudulent entity based on comparing it to information associated with the various entities. In either case, the MLM may be configured to generate a probability (e.g., a score, ranking, value, range, etc.) of fraud associated with the entity. In some embodiments, the probability may be based on click data, transaction data, data extracted from the website, and/or dispute data associated with one or more entities (e.g., including the entity-at-issue).

In block 112, the fraud detection system 220 may determine, via the MLM, whether the probability of fraud exceeds a first predetermined threshold. In some embodiments, the predetermined threshold may be user-specific, such as based on user preferences, merchant-specific, such as based on merchant type or category, and/or transaction specific, such as based on the value (e.g., amount) of a transaction. For example, a user may have previously specified a lower risk tolerance for certain merchants or types of merchants such that the system may be configured to utilize a lower predetermined threshold for those types of merchants. As another example, the user may have previously specified, or the system may be configured to implement a default rule, that for transaction amounts greater than $100, the predetermined threshold may be set at a lower threshold than for transactions under $100. In some embodiments, the predetermined threshold may include a score, ranking, specific value, or range above or within which the MLM is trained to compare the generated probability. For example, the MLM may determine a probability of fraud, e.g., a score, of 80 out of 100 associated with the entity (block 110). The predetermined threshold may be set at 75 out of 100, whereby any entity determined to have a score above 75, is determined to exceed the system's fraud tolerance. As such, an entity that receives a score of 80 out of 100, as in the above example, may indicate potential fraud, as further discussed below.

In block 114, responsive to determining the probability of fraud exceeds the first predetermined threshold, the fraud detection system 220 may transmit a notification to the user device, the notification comprising one or more selectable user input objects. In some embodiments, the notification may include an alert including an indication that a website and/or an entity associated with a website may be fraudulent. In some embodiments, the notification may be transmitted to the user before the user has initiated or attempted to initiate a transaction. In such embodiments, the system may be configured to recognize the user has navigated to a website associated with an entity (block 102) and may receive click data (block 104), but may not yet have received a request to complete a transaction (block 106) or retrieved transaction data (block 108). In such embodiments, the one or more selectable user input objects may enable the user to, for example, indicate a preference to continue navigating the website (e.g., a click button that says “cancel” or “dismiss”), or to receive additional information (e.g., a click button that says “more information”).

Alternatively, in such embodiments where the system has received a request to complete a transaction (block 106) and/or has retrieved transaction data (block 108), the system may be configured to transmit a notification to the user that enables the user to cancel or proceed with the initiated transaction. For example, the one or more selectable user input objects may enable the user to, for example, indicate that the user's preference to cancel, dispute, or proceed with the initiated transaction (e.g., via click buttons that say “cancel,” “dispute transaction,” or “proceed”).

In block 116, further responsive to determining the probability of fraud exceeds the first predetermined threshold, the fraud detection system 220 may cause the user device to display the notification via a GUI. In some embodiments, the notification may be displayed, for example, across a header of the website, as a pop-up window, within the browser plugin, and the like.

In optional block 118, the fraud detection system 220 may receive, via the GUI of the user device, a first selection of a first user input object of the one or more selectable user input objects. For example, as discussed above, the user may be presented with multiple click buttons within the notification or alert, and may select one or more of the presented click buttons.

In optional block 120, responsive to receiving the first selection, the fraud detection system 220 may authorize the transaction. For example, the system may receive indication from the user that he/she would prefer to proceed with the initiated transaction, as discussed above, and may, for example, click on a button in the notification that reads “proceed.” In such case, the system may be configured to authorize the transaction. For example, an organization that owns and/or operates the fraud detection system 220 may authorize the transaction upon receiving the user's selection via the web browser plugin.

In optional block 122, further responsive to receiving the first selection, the fraud detection system 220 may update the GUI to indicate the transactions is authorized. For example, the system may be configured to modify the GUI such that the first notification is removed, and a second notification (e.g., a different pop-up window) appears on the screen that notifies the user that the transaction was authorized. In some embodiments, the two notifications may be formatted differently depending on their content. For example, the first notification, indicating the user may have conducted a transaction with a fraudulent entity, may be formatted with a red, bold border around the notification, while the second notification, indicating the transaction was authorized, may be formatted with a green border.

In optional block 124, responsive to receiving the first selection, the fraud detection system 220 may decline the transaction. For example, the system may receive indication from the user that he/she would prefer to cancel or dispute the initiated transaction, as discussed above, and may, for example, click on a button in the notification that reads “cancel” or “dispute.” In such case, the system may be configured to decline the transaction. For example, an organization that owns and/or operates the fraud detection system 220 may decline the transaction and/or initiate a dispute process upon receiving the user's selection via the web browser plugin.

In optional block 126, further responsive to receiving the first selection, the fraud detection system 220 may update the GUI to indicate the transaction is declined. For example, the system may be configured to modify the GUI such that the first notification is removed, and a second notification (e.g., a different pop-up window) appears on the screen that notifies the user that the transaction was declined. In some embodiments, the two notifications may be formatted differently depending on their content. For example, the first notification, indicating the user may have conducted a transaction with a fraudulent entity, may be formatted with a red, bold border around the notification, while the second notification, indicating the transaction was declined, may be formatted with a yellow border.

FIG. 2 is a block diagram of an example fraud detection system 220 used to determine a probability of fraud associated with an entity according to an example implementation of the disclosed technology. According to some embodiments, the user device 302 and web server 310, as depicted in FIG. 3 and described below, may have a similar structure and components that are similar to those described with respect to fraud detection system 220 shown in FIG. 2. As shown, the fraud detection system 220 may include a processor 210, an input/output (I/O) device 270, a memory 230 containing an operating system (OS) 240 and a program 250. In some embodiments, program 250 may include an MLM 252 that may be trained, for example, to determine a probability of fraud associated with an entity and determine whether that probability exceeds a predetermined threshold. In certain implementations, MLM 252 may issue commands in response to processing an event, in accordance with a model that may be continuously or intermittently updated. Moreover, processor 210 may execute one or more programs (such as via a rules-based platform or the trained MLM 252), that, when executed, perform functions related to disclosed embodiments.

In certain example implementations, the fraud detection system 220 may be a single server or may be configured as a distributed computer system including multiple servers or computers that interoperate to perform one or more of the processes and functionalities associated with the disclosed embodiments. In some embodiments fraud detection system 220 may be one or more servers from a serverless or scaling server system. In some embodiments, the fraud detection system 220 may further include a peripheral interface, a transceiver, a mobile network interface in communication with the processor 210, a bus configured to facilitate communication between the various components of the fraud detection system 220, and a power source configured to power one or more components of the fraud detection system 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™ low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the fraud detection system 220 may include one or more storage devices configured to store information used by the processor 210 (or other components) to perform certain functions related to the disclosed embodiments. In one example, the fraud detection system 220 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The fraud detection system 220 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the fraud detection system 220 may include the memory 230 that may include one or more programs 250 to perform one or more functions of the disclosed embodiments. For example, in some embodiments, the fraud detection system 220 may additionally manage dialogue and/or other interactions with the customer via a program 250.

The processor 210 may execute one or more programs 250 located remotely from the fraud detection system 220. For example, the fraud detection system 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a fraud detection system database 260 for storing related data to enable the fraud detection system 220 to perform one or more of the processes and functionalities associated with the disclosed embodiments.

The fraud detection system database 260 may include stored data relating to status data (e.g., average session duration data, location data, idle time between sessions, and/or average idle time between sessions) and historical status data. According to some embodiments, the functions provided by the fraud detection system database 260 may also be provided by a database that is external to the fraud detection system 220, such as the database 316 as shown in FIG. 3.

The fraud detection system 220 may also be communicatively connected to one or more memory devices (e.g., databases) locally or through a network. The remote memory devices may be configured to store information and may be accessed and/or managed by the fraud detection system 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The fraud detection system 220 may also include one or more I/O devices 270 that may comprise one or more interfaces for receiving signals or input from devices and providing signals or output to one or more devices that allow data to be received and/or transmitted by the fraud detection system 220. For example, the fraud detection system 220 may include interface components, which may provide interfaces to one or more input devices, such as one or more keyboards, mouse devices, touch screens, track pads, trackballs, scroll wheels, digital cameras, microphones, sensors, and the like, that enable the fraud detection system 220 to receive data from a user (such as, for example, via the user device 302).

In examples of the disclosed technology, the fraud detection system 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The fraud detection system 220 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another MLM. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The fraud detection system 220 may be configured to adjust model parameters during training. Model parameters may include weights, coefficients, offsets, or the like. Training may be supervised or unsupervised.

The fraud detection system 220 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The fraud detection system 220 may be configured to optimize statistical models using known optimization techniques.

Furthermore, the fraud detection system 220 may include programs configured to retrieve, store, and/or analyze properties of data models and datasets. For example, fraud detection system 220 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The fraud detection system 220 may include algorithms to determine a data type, key-value pairs, row-column data structure, statistical distributions of information such as keys or values, or other property of a data schema may be configured to return a statistical profile of a dataset (e.g., using a data-profiling model). The fraud detection system 220 may be configured to implement univariate and multivariate statistical methods. The fraud detection system 220 may include a regression model, a Bayesian model, a statistical model, a linear discriminant analysis model, or other classification model configured to determine one or more descriptive metrics of a dataset. For example, fraud detection system 220 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The fraud detection system 220 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, fraud detection system 220 may be configured to generate a similarity metric representing a measure of similarity between data in a dataset. A similarity metric may be based on a correlation, covariance matrix, a variance, a frequency of overlapping values, or other measure of statistical similarity.

The fraud detection system 220 may be configured to generate a similarity metric based on data model output, including data model output representing a property of the data model. For example, fraud detection system 220 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The fraud detection system 220 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The fraud detection system 220 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, fraud detection system 220 is configured to generate and/or train a classification model to classify a dataset, consistent with disclosed embodiments.

The fraud detection system 220 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the fraud detection system may analyze information applying machine-learning methods.

While the fraud detection system 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the fraud detection system 220 may include a greater or lesser number of components than those illustrated.

FIG. 3 is a block diagram of an example system that may be used to view and interact with fraud management system 308, according to an example implementation of the disclosed technology. The components and arrangements shown in FIG. 3 are not intended to limit the disclosed embodiments as the components used to implement the disclosed processes and features may vary. As shown, fraud management system 308 may interact with a user device 302 via a network 306. In certain example implementations, the fraud management system 308 may include a local network 312, a fraud detection system 220, a web server 310, and a database 316.

In some embodiments, a user may operate the user device 302. The user device 302 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 306 and ultimately communicating with one or more components of the fraud management system 308. In some embodiments, the user device 302 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the fraud management system 308. According to some embodiments, the user device 302 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The fraud detection system 220 may include programs (scripts, functions, algorithms) to configure data for visualizations and provide visualizations of datasets and data models on the user device 302. This may include programs to generate graphs and display graphs. The fraud detection system 220 may include programs to generate histograms, scatter plots, time series, or the like on the user device 302. The fraud detection system 220 may also be configured to display properties of data models and data model training results including, for example, architecture, loss functions, cross entropy, activation function values, embedding layer structure and/or outputs, convolution results, node outputs, or the like on the user device 302.

The network 306 may be of any suitable type, including individual connections via the internet such as cellular or WiFi networks. In some embodiments, the network 306 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 306 may include any type of computer networking arrangement used to exchange data. For example, the network 306 may be the Internet, a private data network, virtual private network (VPN) using a public network, and/or other suitable connection(s) that enable(s) components in the system 300 environment to send and receive information between the components of the system 300. The network 306 may also include a PSTN and/or a wireless network.

The fraud management system 308 may be associated with and optionally controlled by one or more entities such as a business, corporation, individual, partnership, or any other entity that provides one or more of goods, services, and consultations to individuals such as customers. In some embodiments, the fraud management system 308 may be controlled by a third party on behalf of another business, corporation, individual, partnership. The fraud management system 308 may include one or more servers and computer systems for performing one or more functions associated with products and/or services that the organization provides.

Web server 310 may include a computer system configured to generate and provide one or more websites accessible to customers, as well as any other individuals involved in access system 308's normal operations. Web server 310 may include a computer system configured to receive communications from user device 302 via for example, a mobile application, a chat program, an instant messaging program, a voice-to-text program, an SMS message, email, or any other type or format of written or electronic communication. Web server 310 may have one or more processors 322 and one or more web server databases 324, which may be any suitable repository of website data. Information stored in web server 310 may be accessed (e.g., retrieved, updated, and added to) via local network 312 and/or network 306 by one or more devices or systems of system 300. In some embodiments, web server 310 may host websites or applications that may be accessed by the user device 302. For example, web server 310 may host a financial service provider website that a user device may access by providing an attempted login that are authenticated by the fraud detection system 220. According to some embodiments, web server 310 may include software tools, similar to those described with respect to user device 302 above, that may allow web server 310 to obtain network identification data from user device 302. The web server may also be hosted by an online provider of website hosting, networking, cloud, or backup services, such as Microsoft Azure™ or Amazon Web Services™.

The local network 312 may include any type of computer networking arrangement used to exchange data in a localized area, such as WiFi, Bluetooth™, Ethernet, and other suitable network connections that enable components of the fraud management system 308 to interact with one another and to connect to the network 306 for interacting with components in the system 300 environment. In some embodiments, the local network 312 may include an interface for communicating with or linking to the network 306. In other embodiments, certain components of the fraud management system 308 may communicate via the network 306, without a separate local network 306.

The fraud management system 308 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 302 may be able to access fraud management system 308 using the cloud computing environment. User device 302 may be able to access fraud management system 308 using specialized software. The cloud computing environment may eliminate the need to install specialized software on user device 302.

In accordance with certain example implementations of the disclosed technology, the fraud management system 308 may include one or more computer systems configured to compile data from a plurality of sources the fraud detection system 220, web server 310, and/or the database 316. The fraud detection system 220 may correlate compiled data, analyze the compiled data, arrange the compiled data, generate derived data based on the compiled data, and store the compiled and derived data in a database such as the database 316. According to some embodiments, the database 316 may be a database associated with an organization and/or a related entity that stores a variety of information relating to customers, transactions, ATM, and business operations. The database 316 may also serve as a back-up storage device and may contain data and information that is also stored on, for example, database 260, as discussed with reference to FIG. 2.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a user may be a customer of a financial institution. The user may have a web browser plugin running on the user's device (e.g., laptop computer), where the plugin is owned and/or operated by the financial institution. The plugin may be configured such that it monitors websites the user visits and can determine when the user has navigated to a website associated with an entity, such as a merchant of goods and/or services. Once the user is on the website associated with the merchant, the plugin may be configured to receive click data associated with the website, such as a URL, referring URL, timestamp, and the like. A system also owned and/or operated by the financial institution may be configured to communicate with the web browser plugin, and may receive a request from the user to complete a transaction. For example, on the merchant website, the user may add one or more items to the user's cart and then initiate a transaction to purchase the items by, for example, clicking on a “buy” or “proceed to payment” button. The system may receive notification that the user has initiated this purchase, and may be configured to retrieve transaction data associated with the transaction, such as merchant name or identifier, types of goods and/or services, transaction price, date, time, method of payment (e.g., credit card account), etc. Based on the click data and transaction data, the system may be configured to determine, using a trained MLM, a probability of fraud associated with the website merchant. The model may be trained to compare the click data and transaction data with historical click, transaction, website, and/or dispute data associated with the merchant or other merchants to determine a likelihood (e.g., based on a predetermined scale or range) that the merchant and/or its website is associated with fraud or otherwise malicious activity.

If the system determines the probability of fraud exceeds a predetermined threshold, the system may transmit a notification to the user device, for example, via a pop-up notification on the user's screen. The notification may alert the user to the fact that the user may have potentially conducted a transaction with a fraudulent or malicious merchant. The notification may include one or more selectable buttons that read, for example, “cancel,” “ignore,” “proceed,” “complete transaction anyway,” “more information,” “cancel transaction,” “dispute transaction,” etc., such that the user may indicate a preference for how the system should proceed following the user's potentially fraudulent transaction. If the user clicks “ignore,” for example, the system may be configured to remove the notification from the screen and authorize the transaction. In such a case, the system may update the GUI of the user's device to display a second notification that indicates the user's purchase was authorized. If the user clicks “more information,” for example, the system may modify the GUI of the user's screen and generate and display another pop-up window that includes information related to this merchant and/or website (e.g., that the system is aware of a certain number of previous disputes made by customers who transacted with this merchant). If the user clicks “cancel transaction,” for example, the system may be configured to remove the notification from the screen and decline the transaction. In such case, the system may update the GUI of the user's device to display a second notification that indicates the user's purchase was declined.

In some examples, disclosed systems or methods may involve one or more of the following clauses:

Clause 1: A system for verifying a website is not associated with malicious activity, comprising: one or more processors; and a memory in communication with the one or more processors and storing instructions that, when executed by the one or more processors, are configured to cause the system to: determine that a user has navigated to a website associated with an entity; receive, via a web browser plugin on a user device, first click data associated with the website; receive a request to complete a transaction via the website; retrieve transaction data associated with the transaction; determine, via a machine learning model (MLM), a probability of fraud associated with the entity based on the first click data and the transaction data; determine, via the MLM, whether the probability of fraud exceeds a first predetermined threshold; responsive to determining the probability of fraud exceeds the first predetermined threshold: transmit a notification to the user device, the notification comprising one or more selectable user input objects; and cause the user device to display the notification via a graphical user interface (GUI); and responsive to receiving, via the GUI of the user device, a first selection of a first user input object of the one or more selectable user input objects decline the transaction and update the GUI to indicate the transaction is declined.

Clause 2: The system of clause 1, wherein the instructions are further configured to cause the system to: extract website data from the website, wherein determining the probability of fraud associated with the entity is further based on the website data.

Clause 3: The system of clause 1, wherein the instructions are further configured to cause the system to: receive dispute data associated with one or more first entities, wherein determining the probability of fraud associated with the entity is further based on the dispute data.

Clause 4: The system of clause 3, wherein the one or more first entities comprise the entity.

Clause 5: The system of clause 1, wherein the transaction data comprises one or more of a transaction amount, an entity name, account identification data, a date, a time, or combinations thereof.

Clause 6: The system of clause 1, wherein the first click data comprises a referring uniform resource location (URL), a current URL, a date, a time, account identification data, user identification data, or combinations thereof.

Clause 7: The system of clause 1, wherein the instructions are further configured to cause the system to: responsive to receiving the first selection of the one or more selectable user input objects via the GUI of the user device, authorize the transaction and update the GUI to indicate that the transaction has been authorized.

Clause 8: A system for verifying a website is not associated with malicious activity, comprising: one or more processors; and a memory in communication with the one or more processors and storing instructions that, when executed by the one or more processors, are configured to cause the system to: determine that a user has navigated to a website associated with an entity; receive, via a web browser plugin on a user device, first click data associated with the website; receive a request to complete a transaction; receive transaction data associated with the transaction; determine, via a machine learning model (MLM), a probability of fraud associated with the entity based on the first click data and the transaction data; determine, via the MLM, whether the probability of fraud exceeds a first predetermined threshold; responsive to determining the probability of fraud exceeds the first predetermined threshold: transmit a notification to the user device, the notification comprising one or more selectable user input objects; and cause the user device to display the notification via a graphical user interface (GUI); and receive, via the GUI of the user device, a first selection of a first user input object of the one or more selectable user input objects; and responsive to receiving the first selection, authorize the transaction.

Clause 9: The system of clause 8, wherein the instructions are further configured to cause the system to: determine whether a predetermined amount of time has passed without receiving any selection of the one or more selectable user input objects; and responsive to determining the predetermined amount of time has passed without receiving any selection, decline the transaction.

Clause 10: The system of clause 8, wherein the instructions are further configured to cause the system to: receive, via the GUI of the user device, a second selection of a second user input object of the one or more selectable user input objects; and responsive to receiving the second selection, decline the transaction.

Clause 11: The system of clause 8, wherein the instructions are further configured to cause the system to: extract website data from the website, wherein determining the probability of fraud associated with the entity is further based on the website data.

Clause 12: The system of clause 8, wherein the instructions are further configured to cause the system to: receive dispute data associated with one or more first entities, wherein determining the probability of fraud associated with the entity is further based on the dispute data.

Clause 13: The system of clause 8, wherein the transaction data comprises one or more of a transaction amount, an entity name, account identification data, a date, a time, or combinations thereof.

Clause 14: The system of clause 8, wherein the first click data comprises a referring uniform resource location (URL), a current URL, a date, a time, account identification data, user identification data, or combinations thereof.

Clause 15: A system for verifying a website is not associated with malicious activity, comprising: one or more processors; and a memory in communication with the one or more processors and storing instructions that, when executed by the one or more processors, are configured to cause the system to: determine that a user has navigated to a website associated with an entity; receive, via a web browser plugin on a user device, first click data associated with the website; determine, via a machine learning model (MLM), a probability of fraud associated with the entity based on the first click data; determine, via the MLM, whether the probability of fraud exceeds a first predetermined threshold; and responsive to determining the probability of fraud exceeds the first predetermined threshold: transmit a notification to the user device; and cause the user device to display the notification via a graphical user interface (GUI).

Clause 16: The system of clause 15, wherein the instructions are further configured to cause the system to: extract website data from the website, wherein determining the probability of fraud associated with the entity is further based on the website data.

Clause 17: The system of clause 15, wherein the instructions are further configured to cause the system to: receive dispute data associated with one or more first entities, wherein determining the probability of fraud associated with the entity is further based on the dispute data.

Clause 18: The system of clause 17, wherein the one or more first entities comprise the entity.

Clause 19: The system of clause 15, wherein the first click data comprises a referring uniform resource location (URL), a current URL, a date, a time, account identification data, user identification data, or combinations thereof.

Clause 20: The system of clause 15, wherein the instructions are further configured to cause the system to: receive a request to complete a transaction; and receive transaction data associated with the transaction, wherein determining the probability of fraud associated with the entity is further based on the transaction data.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for verifying a website is not associated with malicious activity, comprising:
one or more processors; and
a memory in communication with the one or more processors and storing instructions that, when executed by the one or more processors, are configured to cause the system to:
determine that a user has navigated to a website associated with an entity;
receive, via a web browser plugin on a user device, first click data associated with the website;
receive a request to complete a transaction via the website;
retrieve transaction data associated with the transaction;
determine, via a machine learning model (MLM), a probability of fraud associated with the entity based on the first click data and the transaction data;
determine, via the MLM, whether the probability of fraud exceeds a first predetermined threshold;
responsive to determining the probability of fraud exceeds the first predetermined threshold:
transmit a notification to the user device, the notification comprising one or more selectable user input objects; and
cause the user device to display the notification via a graphical user interface (GUI); and
responsive to receiving, via the GUI of the user device, a first selection of a first user input object of the one or more selectable user input objects decline the transaction and update the GUI to indicate the transaction is declined.

2. The system of claim 1, wherein the instructions are further configured to cause the system to:
extract website data from the website,
wherein determining the probability of fraud associated with the entity is further based on the website data.

3. The system of claim 1, wherein the instructions are further configured to cause the system to:
receive dispute data associated with one or more first entities,
wherein determining the probability of fraud associated with the entity is further based on the dispute data.

4. The system of claim 3, wherein the one or more first entities comprise the entity.

5. The system of claim 1, wherein the transaction data comprises one or more of a transaction amount, an entity name, account identification data, a date, a time, or combinations thereof.

6. The system of claim 1, wherein the first click data comprises a referring uniform resource location (URL), a current URL, a date, a time, account identification data, user identification data, or combinations thereof.

7. The system of claim 1, wherein the instructions are further configured to cause the system to:
responsive to receiving the first selection of the one or more selectable user input objects via the GUI of the user device, authorize the transaction and update the GUI to indicate that the transaction has been authorized.

8. A system for verifying a website is not associated with malicious activity, comprising:
one or more processors; and
a memory in communication with the one or more processors and storing instructions that, when executed by the one or more processors, are configured to cause the system to:
determine that a user has navigated to a website associated with an entity;
receive, via a web browser plugin on a user device, first click data associated with the website;
receive a request to complete a transaction;
receive transaction data associated with the transaction;
determine, via a machine learning model (MLM), a probability of fraud associated with the entity based on the first click data and the transaction data;
determine, via the MLM, whether the probability of fraud exceeds a first predetermined threshold;
responsive to determining the probability of fraud exceeds the first predetermined threshold:
transmit a notification to the user device, the notification comprising one or more selectable user input objects; and
cause the user device to display the notification via a graphical user interface (GUI); and
receive, via the GUI of the user device, a first selection of a first user input object of the one or more selectable user input objects; and
responsive to receiving the first selection, authorize the transaction.

9. The system of claim 8, wherein the instructions are further configured to cause the system to:
determine whether a predetermined amount of time has passed without receiving any selection of the one or more selectable user input objects; and
responsive to determining the predetermined amount of time has passed without receiving any selection, decline the transaction.

10. The system of claim 8, wherein the instructions are further configured to cause the system to:
receive, via the GUI of the user device, a second selection of a second user input object of the one or more selectable user input objects; and
responsive to receiving the second selection, decline the transaction.

11. The system of claim 8, wherein the instructions are further configured to cause the system to:
extract website data from the website,
wherein determining the probability of fraud associated with the entity is further based on the website data.

12. The system of claim 8, wherein the instructions are further configured to cause the system to:
receive dispute data associated with one or more first entities,
wherein determining the probability of fraud associated with the entity is further based on the dispute data.

13. The system of claim 8, wherein the transaction data comprises one or more of a transaction amount, an entity name, account identification data, a date, a time, or combinations thereof.

14. The system of claim 8, wherein the first click data comprises a referring uniform resource location (URL), a current URL, a date, a time, account identification data, user identification data, or combinations thereof.

15. A system for verifying a website is not associated with malicious activity, comprising:
one or more processors; and
a memory in communication with the one or more processors and storing instructions that, when executed by the one or more processors, are configured to cause the system to:
determine that a user has navigated to a website associated with an entity;
receive, via a web browser plugin on a user device, first click data associated with the website;
determine, via a machine learning model (MLM), a probability of fraud associated with the entity based on the first click data;
determine, via the MLM, whether the probability of fraud exceeds a first predetermined threshold; and
responsive to determining the probability of fraud exceeds the first predetermined threshold:
transmit a notification to the user device; and
cause the user device to display the notification via a graphical user interface (GUI).

16. The system of claim 15, wherein the instructions are further configured to cause the system to:
extract website data from the website,
wherein determining the probability of fraud associated with the entity is further based on the website data.

17. The system of claim 15, wherein the instructions are further configured to cause the system to:
receive dispute data associated with one or more first entities,
wherein determining the probability of fraud associated with the entity is further based on the dispute data.

18. The system of claim 17, wherein the one or more first entities comprise the entity.

19. The system of claim 15, wherein the first click data comprises a referring uniform resource location (URL), a current URL, a date, a time, account identification data, user identification data, or combinations thereof.

20. The system of claim 15, wherein the instructions are further configured to cause the system to:
receive a request to complete a transaction; and
receive transaction data associated with the transaction,
wherein determining the probability of fraud associated with the entity is further based on the transaction data.
